(19) United States
(12) Patent Application Publication
(10) Pub. No.: US 2026/0162189 A1
(43) Pub. Date: Jun. 11, 2026

(54) METHOD, DEVICE, AND NON-TRANSITORY COMPUTER READABLE MEDIUM FOR IMPROVING COMPUTATIONAL MODELS IN STRATEGIC PLANNING

(71) Applicant: Charles Schwab & Co., Inc., San Francisco, CA (US)

(72) Inventor: Greta CALKINS, San Francisco, CA (US)

(73) Assignee: Charles Schwab & Co., Inc., San Francisco, CA (US)

(21) Appl. No.: 18/977,294

(22) Filed: Dec. 11, 2024

(51) Int. Cl. G06Q 40/10

(52) U.S. Cl. CPC G06Q 40/10

(57) ABSTRACT

A method of improving computational models and providing recommendations for strategic planning includes collecting personalized data associated with a client and a market data; generating a tax code model using a generative artificial intelligence (AI) tool; building and running a tax engine on a tax savings model based on the personalized data and the market data, the tax code model, and tax engine constraints; training the computational models based on results of running the tax engine on the tax savings model; and providing recommendations using the results of running the tax engine and the trained computational models.

### BACKGROUND

### Field

Various example embodiments relate to methods, devices, and non-transitory computer readable mediums for determining financial planning recommendations.

### Description of the Related Art

The statements in this section merely provide background information related to example embodiments and may not constitute prior art.

Financial planning is a service that helps a client, such as an individual or institution, take control of their future by creating a strategy to achieve a client's financial goals. Financial planning may include retirement planning, estate planning, tax liability planning, and other plans that together work to achieve the client's goals.

Due to the complexity of existing tax law and various regulations, an individual or an organization, such as one or more financial advisors, may not be able to provide sophisticated tax liability planning to, for example, a client, and may instead refer the client to a specialist, such as an accountant, to prepare their tax planning strategy. However, since the financial advisor may not understand the intricate details of tax law and an accountant may not understand the intricate details of various investment strategies, the client may not be provided with holistic financial planning.

Moreover, even when tax liability planning is provided by an accountant and/or a financial advisor, such guidance may not be personalized and, moreover, may only be provided periodically, such as on a yearly basis. Accordingly, there may be significant unrealized tax savings opportunities for clients. Such unrealized tax savings opportunities may include, for example, tax savings opportunities available through charitable contributions. Since clients may not be provided with information regarding tax savings opportunities through charitable donations, clients may not meet their philanthropical goals, and likewise charities may not reach the fundraising goals necessary to adequately perform their various charitable functions.

### SUMMARY

At least some example embodiments utilize artificial intelligence (AI) to simplify and enhance tax liability planning.

At least some example embodiments relate to a method of improving computational models and providing recommendations for strategic planning, the method including collecting personalized data associated with a client and a market data; generating a tax code model using a generative artificial intelligence (AI) tool; building and running a tax engine on a tax savings model based on the personalized data and the market data, the tax code model, and tax engine constraints; training the computational models based on results of running the tax engine on the tax savings model; and providing recommendations using the results of running the tax engine and the trained computational models.

In some example embodiments, the tax savings model is one of a plurality of tax savings models, and the method further includes iteratively performing, using each of the plurality of tax savings models, the building and running of the tax engine and the training of the computational models; and integrating ones of the tax savings models that provide sufficient tax savings to improve the computational models.

In some example embodiments, the collecting personalized data includes collecting client account and tax information associated with the client; and collecting subjective information associated with the client.

In some example embodiments, the generating the tax code model includes extracting tax codes from tax code data to output an extracted tax code; determining tax rules from the extracted tax code; coding the tax rules to generate computer executable code; and generating the tax code model from the generated computer executable code.

In some example embodiments, the determining tax rules includes downloading a tax code file from a governmental agency; feeding the tax code file to the generative AI tool; instructing the generative AI tool to extract rules from the tax code file; and saving the extracted rules to a database.

In some example embodiments, the coding the tax rules includes importing each of the tax rules; and iteratively instructing the generative AI tool to process the imported tax rule one-by-one.

In some example embodiments, the generating the tax code model includes defining a tax bracket class, the tax bracket class including a plurality of tax brackets based on the tax code model; defining a tax model class that provides a list of tax objects; creating an instance of the tax model class to produce a tax mode instance; and adding ones of the plurality of tax brackets to the tax model instance based on tax bracket information included in the personalized data.

In some example embodiments, the building and running the tax engine on the tax savings model includes populating engine constraints based on the personalized data and the market data; and generating tax savings information using an engine run based on the engine constraints.

In some example embodiments, the generating the tax savings information includes running the tax engine based on the tax savings model, engine inputs, and the engine constraints, the engine inputs including the personalized data and the market data, the personalized data including tax bracket information to generate a target tax information; calculating a current tax information for the client based on the tax bracket information included in the personalized data and the market data; determining whether a tax savings provided to the client by implementing the tax savings model is greater than a threshold based on the target tax information and the current tax information; and labeling the tax savings model differently based on a result of the determination to differentiate between ones of a plurality of tax savings models that provide sufficient tax savings and ones of the plurality of tax savings models that do not provide the sufficient tax savings.

In some example embodiments, the running the tax engine includes selecting an original security from a client account included in the personalized data; selecting a replacement security from an index fund that meets an index fund cap weight; calculating a present value of the replacement security; selectively saving the tax savings provided to the client for the replacement security to a database based on whether the present value of the replacement security minus the a present value of the original security is less than or equal to a tax loss threshold; and determining a sum of all the tax savings and storing same in the database.

In some example embodiments, the training the computational models includes retrieving, from a database a labeled version of the tax savings model; splitting the labeled data into a training set, a validation set, and a test set; training one of the computational models on the training set using a machine learning algorithm; evaluating a performance of the trained computational model using the validation set; generating a prediction using the trained computational model; saving ones of the predictions that generate tax savings to the database; and selectively tuning weights of parameters associated with the computational models, in response to a determining that the prediction is not within norms.

In some example embodiments, the providing the recommendations includes transmitting recommendations to a terminal of an advisor via an application program interface (API); receiving a selection from the advisor over the API; and transmitting data to the client based on a result of the selection.

Some example embodiments relate to an apparatus configured to improve computational models and provide recommendations in strategic planning, the apparatus including a memory; and at least one processor configured to execute code stored in the memory to configure the apparatus to, collect personalized data associated with a client and a market data, generate a tax code model using a generative artificial intelligence (AI) tool, build and run a tax engine on a tax savings model based on the personalized data and the market data, the tax code model, and tax engine constraints, train the computational models based on results of running the tax engine on the tax savings model, and provide recommendations using the results of running the tax engine and the trained computational models.

In some example embodiments, the at least one processor is configured to execute the code stored in the memory to further configure the apparatus to, iteratively perform, using each of the plurality of tax savings models, the building and running of the tax engine and the training of the computational models, and integrate ones of the tax savings models that provide sufficient tax savings to improve the computational models.

In some example embodiments, the at least one processor is configured to execute the code stored in the memory to configure the apparatus to collect the personalized data by, collecting client account and tax information associated with the client, and collecting subjective information associated with the client.

In some example embodiments, the at least one processor is configured to execute the code stored in the memory to configure the apparatus to generate the tax code model by, extracting tax codes from tax code data to output an extracted tax code, determining tax rules from the extracted tax code, coding the tax rules to generate computer executable code, and generating the tax code model from the generated computer executable code.

In some example embodiments, the at least one processor is configured to execute the code stored in the memory to configure the apparatus to build and run the tax engine on the tax savings model by, populating engine constraints based on the personalized data and the market data, and generating tax savings information using an engine run based on the engine constraints.

In some example embodiments, the at least one processor is configured to execute the code stored in the memory to configure the apparatus to generate the tax savings information by, running the tax engine based on the tax savings model, engine inputs, and the engine constraints, the engine inputs including the personalized data and the market data, the personalized data including tax bracket information to generate a target tax information, calculating a current tax information for the client based on the tax bracket information included in the personalized data and the market data, determining whether a tax savings provided to the client by implementing the tax savings model is greater than a threshold based on the target tax information and the current tax information, and labeling the tax savings model differently based on a result of the determination to differentiate between ones of a plurality of tax savings models that provide sufficient tax savings and ones of the plurality of tax savings models that do not provide the sufficient tax savings.

In some example embodiments, the at least one processor is configured to execute the code stored in the memory to configure the apparatus to train the computational models by, retrieving from a database a labeled version of the tax savings model, splitting the labeled data into a training set, a validation set, and a test set, training one of the computational models on the training set using a machine learning algorithm, evaluating a performance of the trained computational model using the validation set, generating a prediction using the trained computational model, saving ones of the predictions that generate tax savings to the database, and selectively tuning weights of parameters associated with the computational models, in response to a determining that the prediction is not within norms.

In some example embodiments, the at least one processor is configured to execute the code stored in the memory to configure the apparatus to provide the recommendations by, transmitting recommendations to a terminal of an advisor via an application program interface (API), receiving a selection from the advisor over the API, and transmitting data to the client based on a result of the selection.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates an apparatus configured to improve computational models in strategic planning according to example embodiments;

FIG. 2 illustrates a functional diagram of the apparatus according to example embodiments;

FIG. 3 illustrates a flowchart of a method of operating an apparatus to improve computational models in strategic planning according to example embodiments;

FIG. 4 illustrates a flowchart of a method of collecting data according to example embodiments;

FIG. 5 illustrates a flowchart of a method of generating a tax code model according to example embodiments.

FIG. 6 illustrates a flowchart of a method of determining tax rules according to example embodiments;

FIG. 7 illustrates a method of coding the tax rules into tax-rules code according to example embodiments;

FIG. 8 illustrates a flowchart of a method of building a tax code model from coded tax rules according to example embodiments.

FIG. 9 illustrates a flowchart of a method of running a tax engine according to example embodiments;

FIG. 10 illustrates a flowchart of a method of generating tax savings information using the tax engine according to example embodiments;

FIG. 11 illustrates a flowchart of a method of running a tax engine according to example embodiments;

FIG. 12 illustrates a flowchart of a method of training a machine learning model according to example embodiments;

FIG. 13 illustrates a flowchart of a method of providing recommendations to a client according to example embodiments;

FIG. 14A illustrates an example of a Graphical User Interface (GUI) provided to, for example, a financial advisor according to example embodiments; and

FIG. 14B illustrates an example of a data transmitted to, for example, a client according to example embodiments.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures, and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine-readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “computer-readable medium” may include, but is not limited to, portable or fixed storage devices, optical storage devices, wireless channels, and various other mediums capable of storing, containing, or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

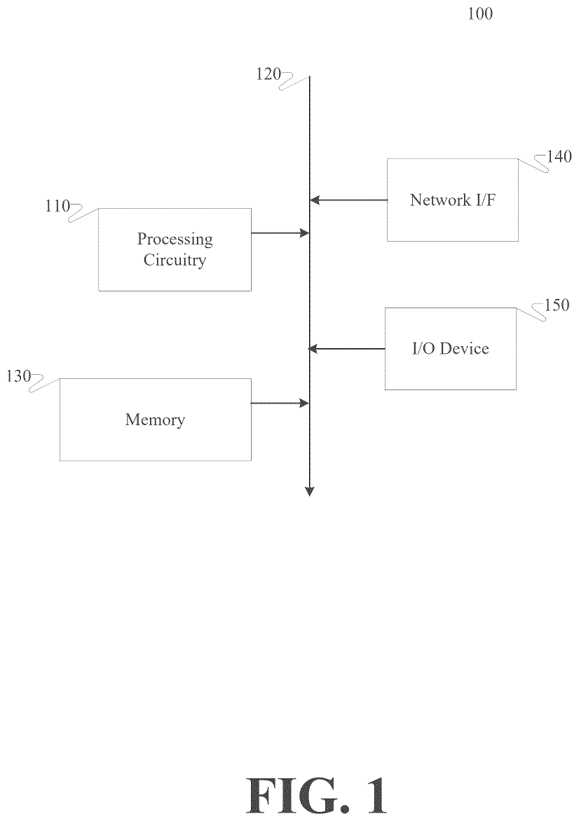

FIG. 1 illustrates an apparatus configured to improve computational models in strategic planning according to example embodiments.

Referring to FIG. 1, an apparatus 100 configured to determine a recommended financial plan may include processing circuitry 110 such as at least one processor, at least one communication bus 120, a memory 130, at least one network interface (I/F) 140, and/or at least one input/output (I/O) device 150 (e.g., a keyboard, a monitor, a touchscreen, a mouse, a microphone, a camera, a speaker, etc.), etc., but the example embodiments are not limited thereto.

The memory 130 may include various special purpose program code including computer executable instructions which may cause the apparatus 100 to perform the method of the example embodiments, including but not limited to determining financial planning recommendations.

In at least one example embodiment, the processing circuitry 110 may include processor cores, distributed processors, or networked processors. The processing circuitry 110 may be configured to control one or more elements of the apparatus 100, and thereby cause the apparatus 100 to perform various operations. The processing circuitry 110 is configured to execute processes by retrieving program code (e.g., computer readable instructions) and data from the memory 130 to process them, thereby executing special purpose control and functions of the apparatus 100. Once the special purpose program instructions are loaded into, (e.g., the at least one processor), the processing circuitry 110 executes the special purpose program instructions, thereby transforming the processing circuitry 110 into a special purpose processor.

In at least one example embodiment, the memory 130 may be a non-transitory computer-readable storage medium and may include a random access memory (RAM), a read only memory (ROM), and/or a permanent mass storage device such as a disk drive, or a solid-state drive. Stored in the memory 130 is program code (i.e., computer readable instructions) related to execution of the methods of example embodiments, and controlling the at least one network interface 140, and/or at least one I/O device 150, etc.

Such software elements may be loaded from a non-transitory computer-readable storage medium independent of the memory 130, using a drive mechanism (not shown) connected to the apparatus 100, or via the at least one network interface 140, and/or at least one I/O device 150, etc.

In at least one example embodiment, the at least one communication bus 120 may enable communication and/or data transmission to be performed between elements of the apparatus 100. The at least one communication bus 120 may be implemented using a high-speed serial bus, a parallel bus, and/or any other appropriate communication technology. According to some example embodiments, the apparatus 100 may include a plurality of communication buses (not shown).

While FIG. 1 depicts an example embodiment of the apparatus 100, the apparatus 100 is not limited thereto, and may include additional and/or alternative architectures that may be suitable for the purposes demonstrated. For example, the functionality of the apparatus 100 may be divided among a plurality of physical, logical, and/or virtual servers and/or computing devices, network elements, etc.

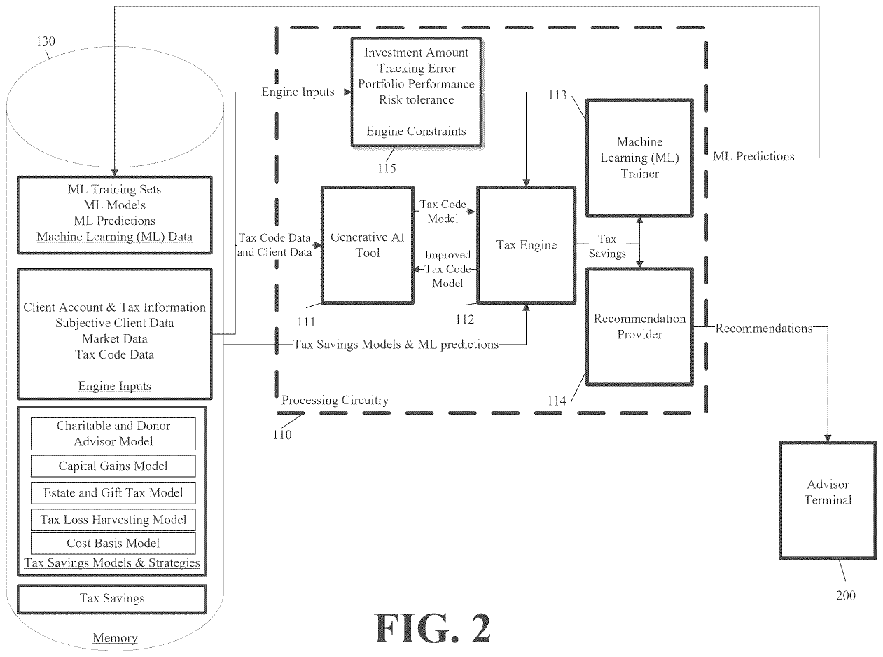

FIG. 2 illustrates a functional diagram of the apparatus according to example embodiments;

Referring to FIG. 2, the processing circuitry 110 may be configured as a special purpose processor to perform the functions of a generative AI tool 111 configured to generate a tax code model, a tax engine 112 configured to determine tax savings for the tax code model, a machine learning trainer 113 configured to train a machine learning model based on the tax savings, and a recommendation provider 114 configured to determine recommendations based on the tax savings. Further, the processing circuitry 110 may populate a set of engine constraints 115 used by the aforementioned tax engine 112.

The generative AI tool 111 may be an artificial intelligence system that works with large language models and is configured to read an input information and convert the input information to a programming language such as python code, and to generate algorithmic models from the programming language.

While FIG. 2 illustrates the processing circuitry 110 of the apparatus 100 performing the functions of the generative AI tool 111, example embodiments are not limited thereto. For example, the generative AI tool 111 may be an external third-party tool available via, for example external third-party tool available via, for instance, a cloud-based infrastructure or distributed computing environment.

The memory 130 may store personalized data for the client such as client account information, client tax information, and subjective client data associated with the client. Further, the memory 130 may store market data and a publicly available version of tax code data, such as a latest version of the Internal Revenue Service (IRS) tax code. As discussed in more detail below, this information may collective be referred to as “engine inputs” that are utilized to populate the set of engine constraints 115 utilized by the tax engine 112.

The subjective client data may include information regarding the client such as the client's risk tolerance, target investment amount that the client is willing to invest, charitable preferences, and tax bracket information. The charitable preferences may include information regarding charities and causes the client is interested in funding. The tax bracket information may include information on the client's tax bracket.

The client information may include account information and tax information for the client. The market data may include index funds and market security pricing.

The generative AI tool 111 may generate a tax code model using the input tax code data, which may be downloaded from, for example, a governmental agency.

The tax engine 112 may receive the generated tax code model, as well as machine learning (ML) data, and tax savings models and generate information on the tax implications for the client regarding the input tax savings model. Further, the tax engine 112 may also generate an improved tax code model based on the tax code model input from the generative AI tool 111, and provide the improved tax code model back to the generative AI tool 111 to improve the functioning of the apparatus 100.

The machine learning (ML) data may include a machine learning training set, a machine learning model, and a machine learning prediction. The tax savings models utilized by tax engine 112 may include a charitable and donor advisor model, a cost basis model, a capital gains model, an estate and gift tax model and a tax loss harvesting model. The tax loss harvesting model and its generation is explained later in this document. The other tax savings models can be created using the same apparatus and mechanism with the same existing client and market data. These tax savings models represent investment and asset allocation strategies that can help produce investment recommendations for lowering the overall tax liabilities. tax savings models are based on computational code with some of the tax savings models being linear regression models that show the relationship between investment and asset allocation strategies, and some of the tax savings models being statistical models as well.

The machine learning trainer 113 may test the different tax savings models and strategies one-by-one to learn over time what models generate savings and what models do not generate tax savings. The machine learning trainer 113 uses data from the tax saving models to generate predictions of tax savings and saves which of the generated machine learning (ML) predictions provide tax savings to the database (e.g., the memory 130).

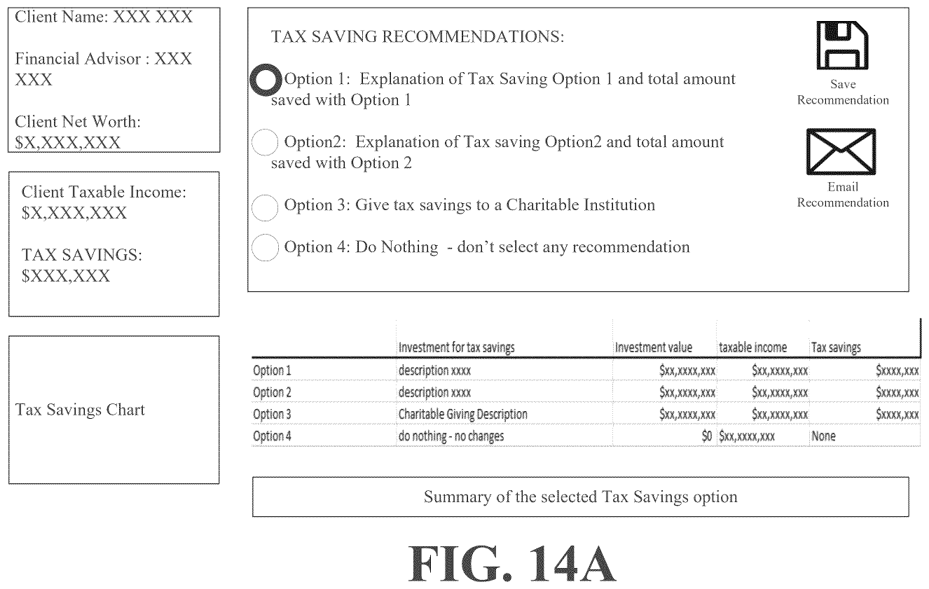

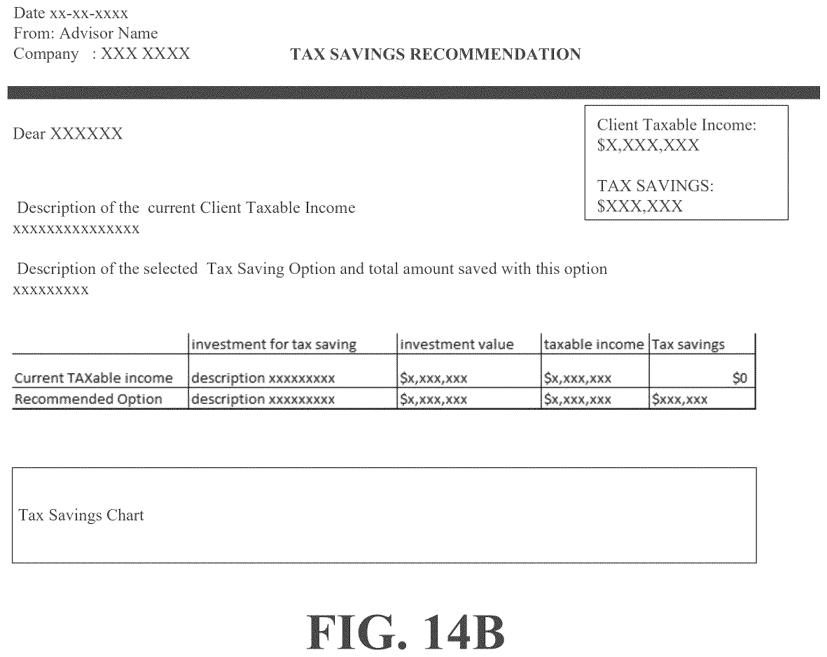

The recommendation provider 114 may receive tax savings information from the tax engine 112 and provides the tax saving recommendations to a financial advisor via the UI in FIGS. 14A and 14B.

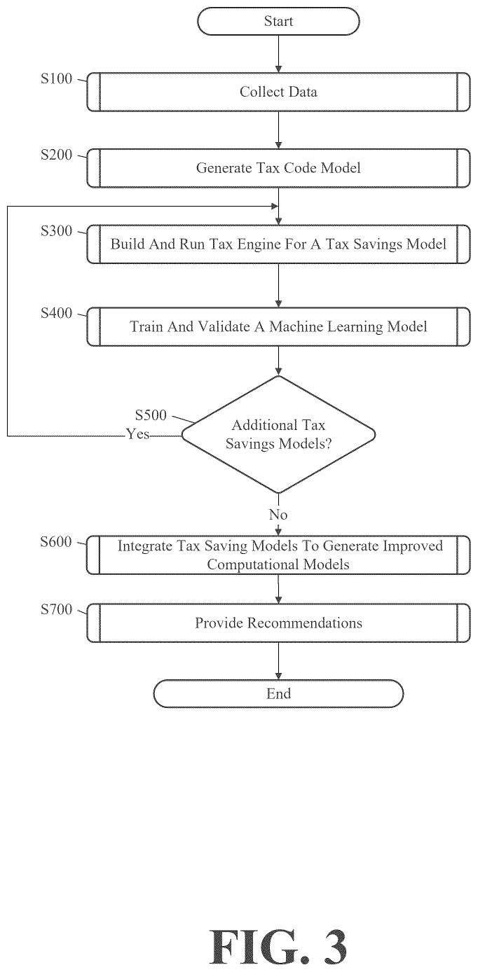

FIG. 3 illustrates a flowchart of a method of operating an apparatus to improve computational models in strategic planning according to example embodiments.

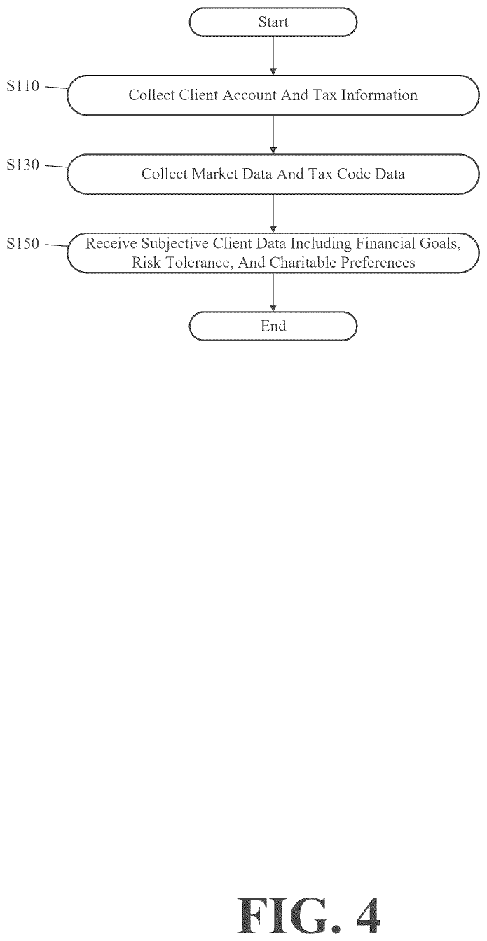

Referring to FIGS. 1 to 3, in operation S100, the apparatus 100, such as the generative AI tool 111, may receive collected data from the memory 130, such as client information, subjective client data, market data, and the tax code data. Operation S100 will be discussed in more detail below with reference to FIG. 4.

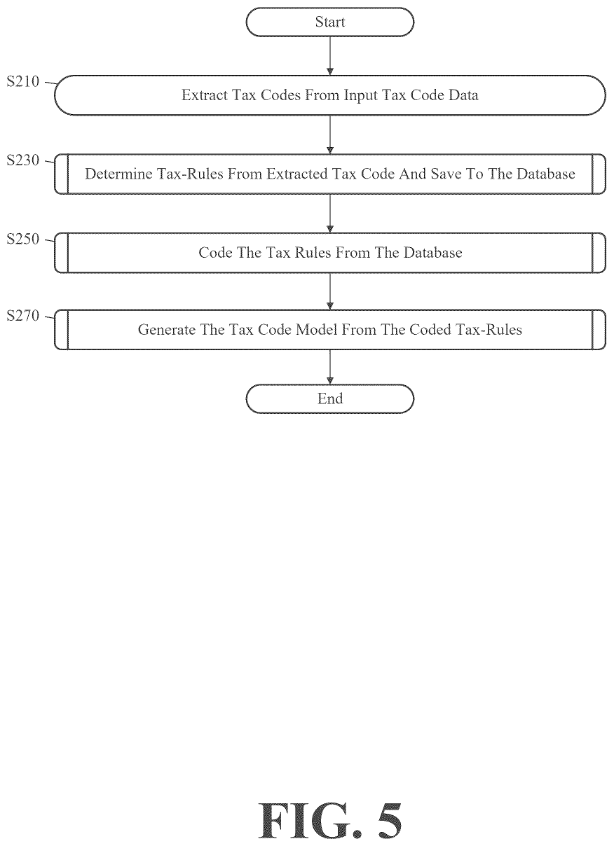

In operation S200, the apparatus 100, such as the generative AI tool 111, may generate a tax code model. For example, the apparatus 100 may use the tax code data collected from a governmental agency such as the IRS to generate a tax code model for optimizing tax liabilities. The generative AI tool 111 may import a PDF tax code from a governmental tax bureau's database, extract tax rules from the import tax code, convert the extracted tax rules to a programming language and generate the tax code model from the coded tax rules. Operation S200 will be discussed in more detail below with reference to FIGS. 5 to 8.

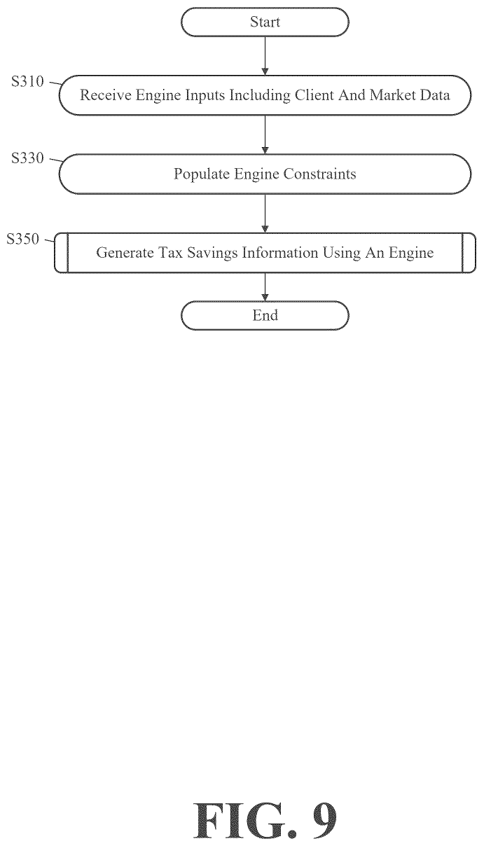

In operation S300, the apparatus 100 may build and run a tax engine 112 for a tax savings model. For example, the apparatus 100 may receive the engine inputs, populate the set of engine constraints 115, run the tax engine 112 for each of the tax saving models, compare the tax savings for the tax saving model against the amount of taxes the client is liable for if no action is taken, and provide an improved tax code model to the generative AI tool 111 to improve the functioning of the apparatus 100. Operation S300 will be discussed in more detail below with reference to FIGS. 9 to 11.

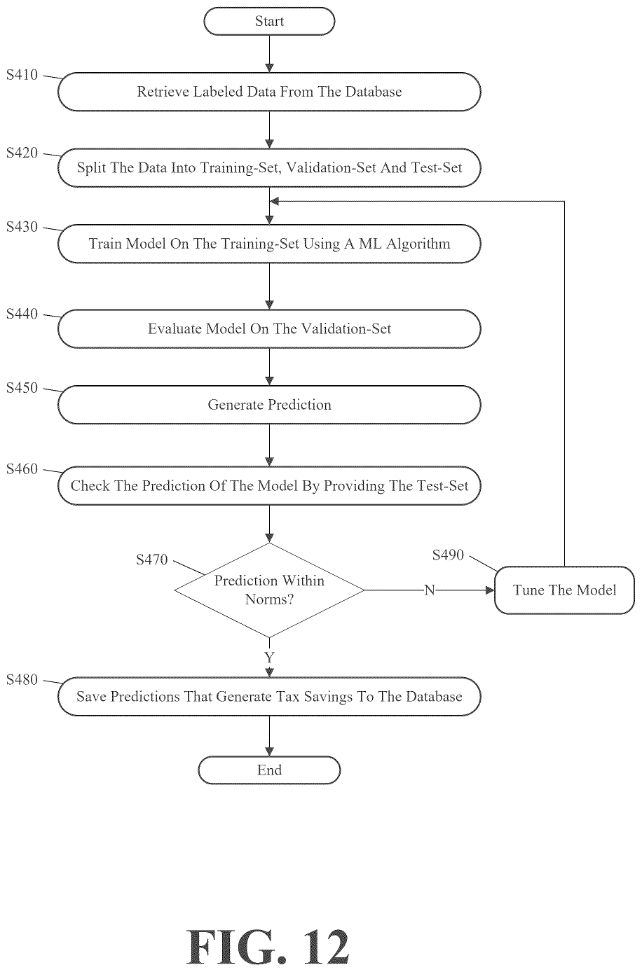

In operation S400, the apparatus 100 may train a machine learning (ML) model. For example, the apparatus 100 may use labeled training data saved in the database that indicates which tax strategies generate tax savings and which tax strategies do not generate tax savings for each individual client and save the machine predictions that generate tax savings to the database. Operation S400 will be discussed in more detail below with reference to FIG. 12.

In operation S500, the apparatus 100 may determine whether there are additional tax savings models to analyze for the client. For example, the apparatus 100 may look if all tax savings models have been applied given the personal client information and engine constraints If there are no additional tax savings models to analyze, the apparatus 100 may proceed to operation S600. If there are additional tax savings models to analyze, the apparatus 100 may advance to the next tax savings model and iteratively perform each of operations S300 and S400 to repopulate the engine constraints, build and run a tax engine for the next tax savings model and train and validate a machine learning model using the tax engine.

In operation S600, the apparatus 100 may integrate a plurality of tax savings models including the charitable and donor advisor model that provide tax savings, and store the results as improved computational models. As the apparatus 100 trains and integrates these models, the integrated computational models may be subsequently called up and utilized without further training and, thus the system may become more efficient and utilize less computing power. Further, since artificial intelligence requires vast computational power, usually utilizing expensive graphical processing units (GPUs) with thousands of smaller cores designed for massive parallelism, the integration of only the tax savings models learned over time that provide sufficient savings reduces the computational complexity and energy consumed by the apparatus 100, and may allow the processing circuitry 110 to be implemented using more cost effective central processing units (CPUs), which have fewer cores.

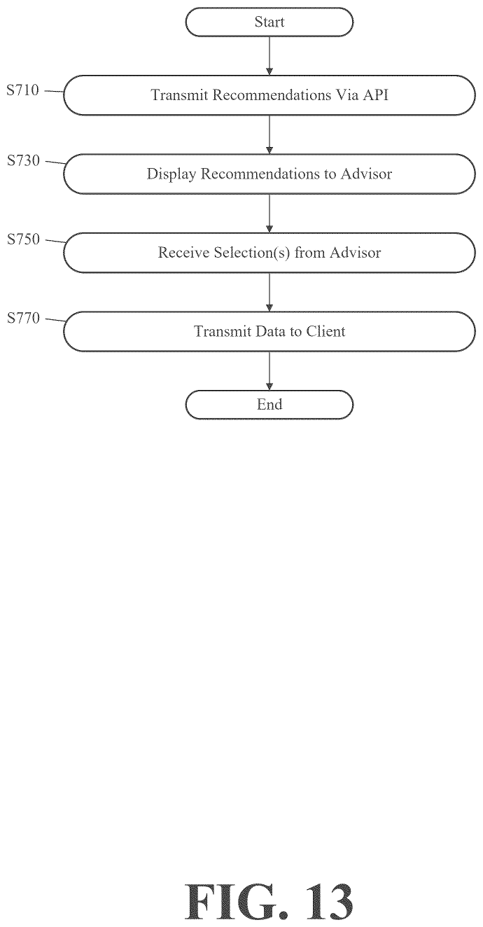

In operation S700, the apparatus 100 may provide results. For example, the apparatus 100 may provide tax savings recommendations if the target tax for the tax savings model is less than the current client tax plus the threshold that is specified by the advisor. The tax saving recommendations may be saved in a database. Operation S700 will be discussed in more detail below with reference to FIG. 13.

As discussed in more detail below, by improving the machine learning model, the apparatus 100 may utilize use less computer power and less time as the machine learning model is trained and learns to identify which tax savings models provide tax benefit and which do not, and may learn to only compute the tax savings models for each user that are most likely to provide benefits, vs. computing every tax savings model for every user.

FIG. 4 illustrates a flowchart of a method of collecting data according to example embodiments.

Referring to FIGS. 1 to 4, as discussed above, the apparatus 100 may collect data, such as client information, subjective client data, market data and tax code data, and the collected data may be stored in the memory 130 and provided to the generative AI tool 111 in operation S100.

For example, in operation S110, the apparatus 100 may collect personalized data for the client from the memory 130 such as client account information, client tax information and subjective information associated with the client. For example, the apparatus 100 may load all client holdings that are part of each client account into database storage. Additional data that may be collected may include all brokerage, IRAs, 401K, savings, checking, other retirement accounts and the balances and security investments for these accounts. Further, the additional data may also include the client's current tax bracket, tax jurisdiction and last year's tax return.

In operation S130, the apparatus 100 may collect market data and tax code data from the memory 130. For example, the apparatus 100 may collect direct market data feeds for the current market benchmarks, and yields. Further, the apparatus 100 may collect the tax code in, for example, PDF format from the Internal Revenue Service (IRS) website or other publicly accessible system.

In operation S150, the apparatus 100, such as the generative AI tool 111, may receive subjective client data. For example, the apparatus 100 may collect subjective client data such as the client's risk tolerance, target investment amount that the client is willing to invest, and charitable preferences.

FIG. 5 illustrates a flowchart of a method of generating a tax code model according to example embodiments.

Referring to FIGS. 1 to 5, as discussed above, after collecting data in operation S100, the apparatus 100, such as the generative AI tool 111, may generate a tax code model in operation S200.

For example, in operation S210, the apparatus 100 may extract tax codes from the tax code data input into the apparatus 100 in operation S100 (e.g., in operation S130). For example, the apparatus 100 may use the generative AI tool 111 to extract tax code data from one or more documents containing the IRS tax code.

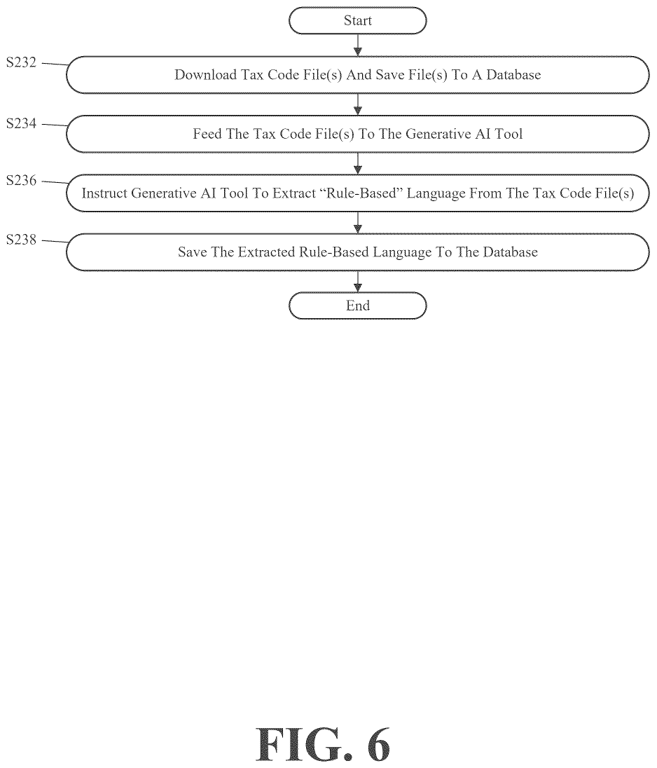

In operation S230, the apparatus 100 may determine tax rules using the extracted tax code data. For example, the Generative AI Tool 111 may extract a “rules-based” language from the tax code data. The apparatus 100 will save the generated “rule-based” language to the database. Operation S230 will be discussed in more detail below with regards to FIG. 6

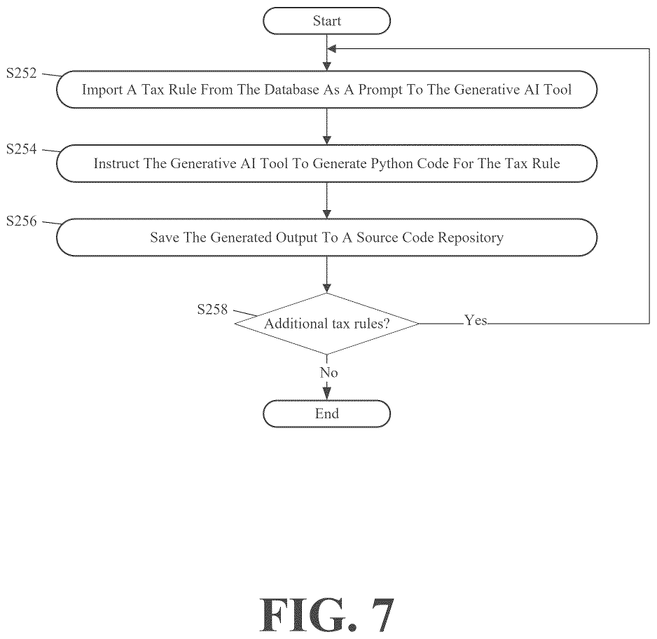

In operation S250, once the ‘rule-based’ language has been saved to the database, the apparatus 100 may generate programming code, such as Python code, from the extracted tax rules language. For example, the apparatus 100 may import each tax rule from the database as a “prompt” to the generative AI tool 111, or Application Program Interface (API), and then prompt the generative AI tool 111 to generate Python code for each rule. The apparatus 100 may save the generated output to a source code repository and advance to the next rule until all rules in the rule-based language are coded. Operation S250 will be discussed in more detail below with regards to FIG. 7.

In operation S270, the apparatus 100 may generate the tax code model from the programming code generated in operation S250.

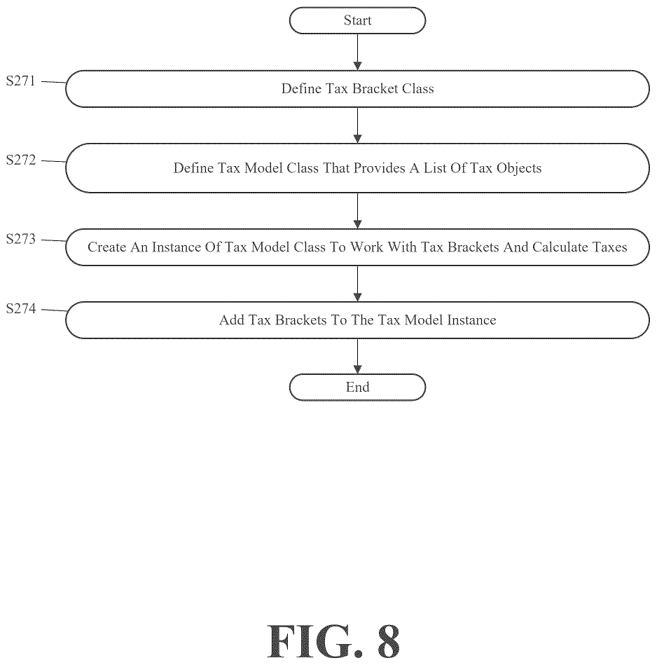

For example, the apparatus 100 may build a tax code model that applies the Python coded tax rules based on predefined conditions and tax brackets. These tax brackets and conditions will be populated based on the client information and market data inputs in later steps. Operation S270 will be discussed in more detail below with reference to FIG. 8.

FIG. 6 illustrates a flowchart of a method of determining tax rules according to example embodiments.

Referring to FIG. 6, in operation S232, the apparatus 100 may download a digital version of the tax code. For example, the generative AI tool 111 may download a digital version of the United States tax code that the Internal Revenue Service (IRS) publishes (or a tax code from any other jurisdiction) as a .pdf document.

In operation S234, the apparatus 100 may feed the tax code into the Generative AI Tool 111.

In operation S236, the apparatus 100 (e.g., the generative AI tool 111) may utilize generative AI prompt-engineering to extract all “rules-based” language from the uploaded digital version of the tax code.

For example, the apparatus 100 may utilize few-shot prompting that uses the in-context learning and real-time prompt optimization to fine-tune the output to only include rules-language.

The Generative AI Tool 111 may receive instructions. The instructions may include a basic instruction, context rules, instructions regarding what portions of the input tax code data to utilize, an output indicator indicating the format of the desired output and few-shot-prompting to provide examples to assist the Generative AI Tool 111. For example, the basic instruction may be an instruction to “extract rules and principles from the uploaded digital version of the tax code.” The context rules may include instructions to “include rules applicable to tax on individuals” and “exclude rules applicable to corporations and business entities.” The input data instructions may instruct the Generative AI Tool 111 as to which portion of the uploaded digital version of the tax code to utilize such as “use title 26 Internal Revenue code documents.” The output indicator instructions may include instructions such as “provide the output as a ‘pseudo code.’” The few-shot-prompting may provide examples to guide the Gen AI response such as instructions that indicate “taxable income is calculated by taking the income and subtracting all standard and itemized deductions.”

In operation S238, the apparatus 100 may save the pseudocode output, generated by the Generative AI Tool 111, in the database.

FIG. 7 illustrates a flowchart of method of coding extracted tax rules into tax-rules code according to example embodiments.

Referring to FIG. 7, in operation S252, the apparatus 100 may import a tax rule from the database as a prompt to the Generative AI Tool.

In operation S254, the apparatus 100 may instruct the Generative AI Tool to generate Python code for the tax rule.

In operation S256, the apparatus 100 may save the generated output as a coded tax rule to a source code repository, which may be a 3^{rd}-party tool such as GitHub. However, example embodiments, are not limited thereto and the source code repository could be internal to the apparatus 100.

In operation S258, the apparatus 100 may determine whether there are any additional tax rules. If the apparatus 100 determines that there are additional rules, the apparatus may proceed back to operation S252 and import this rule from the database and reperform the operations above to generate a coded tax rule (e.g., Python code) for this tax rule. In contrast, if the apparatus 100 determines that there are no additional tax rules, the apparatus 100 may continue to operation S270 and build the tax code model from the coded tax rules.

FIG. 8 illustrates a flowchart of a method of building a tax code model from coded tax rules according to example embodiments.

Referring to FIG. 8, in operation S271, the apparatus 100 creates a tax class object in a programming language such as Python. This tax class object defines a single tax bracket and it contains attributes for the lower bound, upper bound, and tax rate of the tax bracket.

In operation S272, the apparatus 100 defines a tax model class that holds a list of TaxBracket objects and provides methods to add new tax brackets and calculate tax based on the client's income.

In operation S273, the apparatus 100 creates an instance of the TaxModel Class in order to work with the TaxBracket objects and be able to calculate taxes.

In operation S274, the apparatus 100 uses the add_TaxBracket method to add tax brackets to the TaxModel Class Instance.

FIG. 9 illustrates a flowchart of a method of running a tax engine according to example embodiments.

Referring to FIGS. 1 to 3 and 9, as discussed above, the apparatus 100, such as the tax engine 112, may build and run a tax engine in operation S300.

For example, in operation S310, the apparatus 100 may receive engine inputs, which may include the client information, the subjective client data, the market data, and the tax code data. For example, the apparatus 100 may receive the subjective client data and market data from the financial advisor's investment management system.

In operation S330, the apparatus 100 may populate engine constraints. For example, the apparatus 100 may populate, from the financial advisor's investment management system the client's investment amount, tracking error, risk tolerance, and financial portfolio performance as the engine constraints.

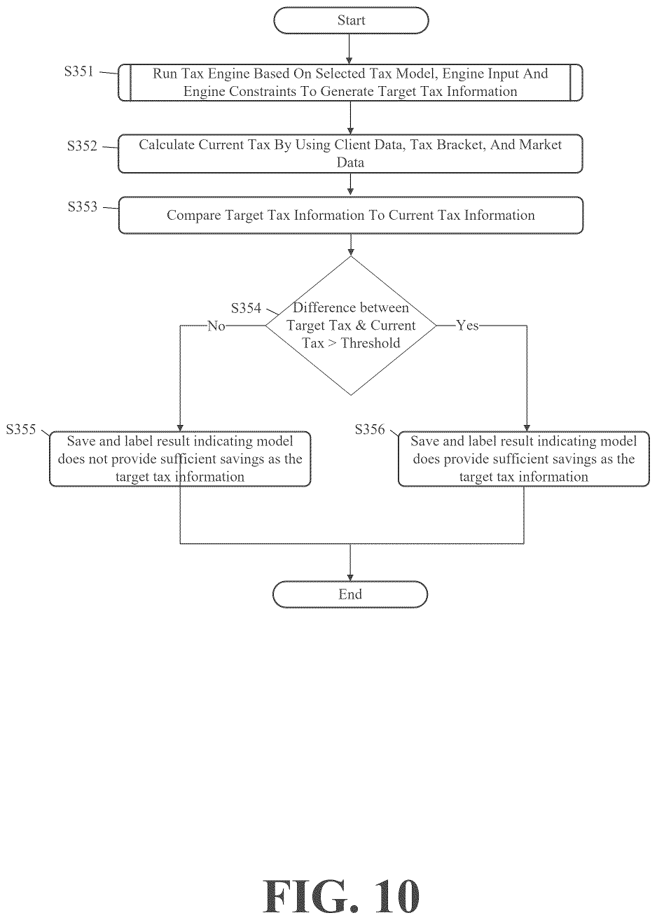

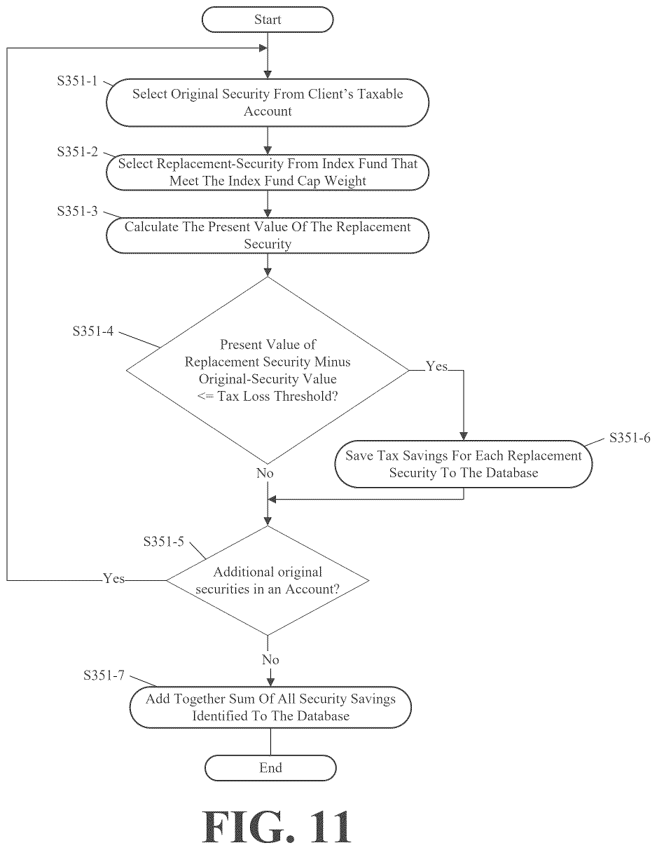

In operation S350, the apparatus 100 may generate tax savings information using the engine. For example, in operation S350, the apparatus 100 may use the tax code model described earlier to calculate the target tax for the client using the client's tax bracket, investment amount, risk tolerance, and market conditions. Operation S350 will be discussed in more detail below with reference to FIGS. 10 and 11.

FIG. 10 illustrates a flowchart of a method of generating tax savings information using the tax engine according to example embodiments.

Referring to FIG. 10, in operation S351, the apparatus 100 may run a tax engine. For example, the apparatus 100 may run the engine based on Tax Model, Engine Input and Constraints to Generate Target Tax Information. For example, the engine may start with the Tax Lot Harvesting Model. The apparatus 100 may use the client tax bracket and client investments input to run the engine, given the investment amount and risk tolerance that the client has provided and calculate the client's Target Tax rate. The engine compares each client's current investment with similar investments that are part of a Market Index fund such as the S&P 500. The Market Index fund is provided as part of the market data to the Engine input. The apparatus 100 may calculate new security present value and compare a result to the old security present value. If the difference is under the tax loss threshold, the apparatus 100 may select the next security from the client account and do the same. At the end, the apparatus 100 harvests security tax losses and calculates the target Client tax. Operation S351 will be discussed in more detail below with reference to FIG. 11.

In operation 352, the apparatus 100 may utilize the client's taxable income that was provided to the database 130 and call the calculate_tax method of the TaxModel Class instance to determine the tax amount.

In operation S353, the apparatus 100 may compare the target tax information generated by running the tax engine 112 to the current tax information for the client. For example, the apparatus 100 may compare the client's current tax rate to the Client's Target Tax rate by applying different tax models.

In operation S354, the apparatus 100 may determine whether a difference between the target tax information generated by running the tax engine 112 and the current tax information for the client is greater than a threshold. For example, the apparatus 100 may subtract the difference between the Target Client tax plus the tax threshold with the current client tax.

In operations S355 and S356, the apparatus 100 may label and save a result for a machine learning training set.

For example, in operation S355, if the difference between the target tax information generated by the tax engine 112 and the current tax information is not greater than the threshold, the apparatus 100 may determine that there is not a sufficient tax savings. If the apparatus 100 determines that there is not a sufficient tax savings, the apparatus 100 may label the tax models as a model that does not generate sufficient tax savings (e.g., label= “no tax savings”), and may save the labeled results in the database.

In operation S356, if the difference between the target tax information generated by the tax engine 112 and the current tax information is greater than the threshold, the apparatus 100 may determine that there is a sufficient tax savings. If the apparatus 100 determines that there is a sufficient tax savings, the apparatus 100 may label the tax strategies as a strategy that does generate sufficient tax savings (e.g., label= “tax savings”), and may save the labeled results in the database.

The apparatus 100 may use the saved and labeled results to train a supervised machine learning (ML) model. Details of using the labeled result to train and validate a machine learning model using supervised training will be discussed below in more detail with reference to operation S400.

FIG. 11 illustrates a flowchart of a method of running a tax engine according to example embodiments.

Referring to FIGS. 10 and 11, as discussed above, in operation S351, the apparatus 100 may run an engine based on a selected tax model.

For example, the selected tax model may be a tax loss harvesting model. However, example embodiments are not limited thereto. FIG. 11 is an example of applying a tax loss harvest strategy.

In operation S351-1, the apparatus 100 may select an investment security stock, for example APPL stock, which is one of the investments that the client has in their taxable brokerage account.

In operation S351-2, the apparatus 100 may determine the cap weight of the selected security (e.g., APPL) within an index (e.g., the S&P 500). The cap weight may be the percentage of the index fund's total assets that the security represents. The apparatus 100 may look for a replacement security that closely tracks the performance of the index and has a similar cap weight from the market index fund input that was provided to the engine.

In operation S351-3, the apparatus 100 may calculate the security's net present value using the formula below:

PV=\frac{CF_1}{(1+r)\hat{ }1}+\frac{CF_2}{(1+r)\hat{ }2}+\ldots+\frac{CF_n}{(1+r)\hat{ }n}\]

Where PV is the present value of the security, CF_t is the cash flow in period t, r is the discount rate to discount the future cash flows back to their present value from the market data provided, n is the number of periods based on the client's investment period which is the client investment period.

In operation S351-4, the apparatus 100 may determine if the present value of the new security meets the tax loss threshold.

If the Tax loss Threshold is not yet met, in operation S351-5, the apparatus 100 moves to the next security or stock from the clients' taxable account. The iteration continues to go through all securities and stocks in the client's taxable account until the tax loss threshold is met.

In operation S351-6, the apparatus 100 may determine the tax harvesting target tax savings amount by applying the tax harvesting model for each security.

In operation S351-7, the apparatus 100 may sum the savings of each of the securities and make this information available to the apparatus 100 when subsequently comparing the target tax information to the current tax information in operation S352.

FIG. 12 illustrates a flowchart of a method of training a machine learning model according to example embodiments;

Referring to FIGS. 1 to 3 and 12, as discussed above, in operation S400, the apparatus 100 may train and validate a machine learning model.

For example, using the saved data that is labeled either “tax savings” or “no tax savings,” the machine learning model may be trained to predict whether another client with similar characteristics (e.g., tax bracket information, investment portfolios, net worth, and/or charitable preferences) would experience tax savings or not given data associated with the new client and current market data.

In operation S410, the apparatus 100 may retrieve previously labeled data, which was labeled in operations S354 and S355, from the database.

In operation S420, the apparatus 100 may split the dataset into a training dataset, a test dataset, and a validation dataset to check whether the predictions are accurate or not. For example, the apparatus 100 may split the retrieved data by utilizing, for example, seventy percent of the dataset as the training dataset, fifteen percent of the dataset as the test dataset, and fifteen percent of the dataset as the validation dataset. However, example embodiments are not limited thereto.

In operation S430, the apparatus 100 may train the machine learning model on the training dataset using a neural network architecture such as a decision tree learning algorithm. In some example embodiments the decision tree learning algorithm may be classification trees or regression trees, however, example embodiments are not limited thereto. The machine learning model may be an MI algorithm structured around parameters that adjust during training to improve performance. These parameters, known as weights, represent the strength or importance of each feature in predicting an outcome. As the machine learning model is trained on a dataset, these weights are iteratively adjusted to minimize error through methods such as gradient descent, which reduces the difference between the predicted and actual outputs. Each weight aligns with a specific feature or node within the model architecture, and its value determines how much influence that feature has on the final prediction.

In operation S440, the apparatus 100 may evaluate the model using the validation dataset to validate that the model performed well during training using the same algorithm but with a different set of data.

In operation S450, the apparatus 100 may generate a prediction. For example, the apparatus 100 may predict whether a tax savings model will generate sufficient tax savings given another client with similar characteristics.

In operation S460, the apparatus 100 may check the prediction of the model by providing the test dataset to the model.

In operation S470, the apparatus 100 may determine whether the prediction of the model is within an acceptable norm, for example, within a desired (or, alternatively a preset) threshold.

In operation S480, if the model is acceptable, the apparatus 100 may save the predictions that generate the tax savings to the database.

In operation S490, if the model falls outside of the acceptable norms, the apparatus 100 may tune the model by adjusting the model's parameters (e.g. adjusting the weights associated with the parameters) and then return to operation S430 and repeat the process.

As such, the apparatus 100 may generate an improved tax code model based on the tax code model input from the generative AI tool 111, and provide the improved tax code model back to the generative AI tool 111 to improve the functioning of the apparatus 100. The improved tax code model may reduce the computation complexity and increase the power efficiency required for the apparatus (e.g., the generative AI tool 111) to generate the tax code model. As the model is trained, it will function better for both different users and for the same user. For the same user it will only calculate the models that provide benefit as it learns which ones provide benefit for that user. For multiple users, it can generalize/categorize multiple users with the same or similar characteristics (e.g., tax bracket information, investment portfolios, net worth, and/or charitable preferences), it can apply the same learnings.

FIG. 13 illustrates a flowchart of a method of providing recommendations to a client according to example embodiments.

Referring to FIGS. 1 to 3 and 13, as discussed above, the apparatus 100 may provide recommendations in operation S700.

For example, in operation S710, the apparatus 100 may transmit recommendations to, for example, a financial advisor via an Application Program Interface (API). For example, the apparatus 100 may push any new tax savings from the tax engine 112 to the recommendation provider 114 that meet the tax savings threshold.

In operation S730, the recommendations may be displayed to the financial advisor via a graphical user interface (GUI). For example, the client device associated with the financial advisor may display an alert that new tax savings recommendations are available for review by the financial advisor. The GUI displayed to the financial advisor may be the GUI discussed in detail below with reference to FIG. 14A.

In operation S750, the apparatus 100 may receive one or more selections from the financial advisor. For example, the apparatus 100 may display two tax savings recommendations as option 1 and option 2. The financial advisor will review both options with the client and will select the tax saving options that the client wants to pursue going forward.

In operation S770, the apparatus 100 may transmit data to the client. For example, the apparatus 100 may send an email to the client with the tax savings option that was selected in the previous step.

FIG. 14A illustrates an example of a Graphical User Interface (GUI) provided to, for example, a financial advisor according to example embodiments.

Referring to FIG. 14A, as discussed above, in operation S730, the apparatus may display, via a GUI, an interface to allow a terminal 200 of a financial advisor to provide recommendations to the client.

For example, the GUI displayed on the terminal 200 may include a client name, financial advisor name and the client's net worth. Also the GUI may display the client's taxable income and may display various provide tax saving recommendation operations, as well may provide the option of doing nothing. The GUI may include a description and tax savings amount for each of the tax saving recommendation options. The GUI may allow the financial advisor to select an option. For example, the options may include multiple tax savings options, as well as the option to donate the tax savings to a charitable institution, or do not implement the tax savings at this time.

Once the option is selected, the GUI may update the summary of the selected tax savings option at the bottom of the screen.

As discussed above, in operation S770, the apparatus 100 may transmit the recommendation to the client. For example, the GUI may provide icons allowing allow the financial advisor to “save” or “send” the generated tax savings recommendations. The send option may be used to, for example, email the selected option and the save option may be used to save the selected recommendation option in the recommendation application and database.

FIG. 14B illustrates an example of tax savings recommendations transmitted to, for example, a client according to example embodiments.

Referring to FIG. 14B, the Tax savings recommendation includes a description of the client's taxable income and the selected tax savings option, as well as the overall tax savings that will be realized by implementing the tax savings recommendation.

As discussed above, minimizing tax liabilities can be complex for several reasons such as constantly changing tax laws, complexity of financial situations for high net worth individuals, interplay of regulations between capital gains income, estate tax, gift tax, and more. Further, in addition to generally minimizing tax liabilities it may be difficult to reduce tax liability for a client while also meeting the client's personal investment and philanthropical goals.

For example, a typical high net worth client with $5 M of taxable income may pay $1.8 M in taxes. Due to the complexity of the code, financial advisors may not be able to provide tax planning and often refer the client to an accountant who does not have investment knowledge and thus, the client may not be provided with holistic guidance. Even when tax guidance is provided, such guidance may not be personalized and/or may be done only sporadically such as once or twice a year. As such, there may be significant tax saving opportunities that are currently untapped. At the same time more than 50% of U.S. charities may not meet their financial goals and, thus, may find it difficult to sufficiently drive impacts for people in need.

Example embodiments harness the power of AI to decipher the tax code and tax guidance into a ML Model and recommendations for savings taxes. AI can help simplify and enhanced tax liability planning by doing quick data analysis, processing and providing recommendations personalized for each client's unique financial and tax situation.

The solution periodically identifies personalized tax-savings for each individual investment portfolio and individual client tax situation. The solution also models the tax impacts of all trades specific to the client's individual situation to optimize after-tax returns.

Example embodiments may provide effective tax planning for high-net-worth individuals and such tax savings can be used for funding a charity that meets the client's philanthropic goals via, for example, a donor-advised fund. In some example embodiments, personalized tax savings and charity recommendations may be sent to an advisor for review prior to being shared with a client.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A method of improving computational models and providing recommendations for strategic planning, the method comprising:
collecting personalized data associated with a client and a market data;
generating a tax code model using a generative artificial intelligence (AI) tool;
building and running a tax engine on a tax savings model based on the personalized data and the market data, the tax code model, and tax engine constraints;
training the computational models based on results of running the tax engine on the tax savings model; and
providing recommendations using the results of running the tax engine and the trained computational models.

2. The method of claim 1, wherein the tax savings model is one of a plurality of tax savings models, and the method further comprises:
iteratively performing, using each of the plurality of tax savings models, the building and running of the tax engine and the training of the computational models; and
integrating ones of the tax savings models that provide sufficient tax savings to improve the computational models.

3. The method of claim 1, wherein the collecting personalized data comprises:
collecting client account and tax information associated with the client; and
collecting subjective information associated with the client.

4. The method of claim 1, wherein the generating the tax code model comprises:
extracting tax codes from tax code data to output an extracted tax code;
determining tax rules from the extracted tax code;
coding the tax rules to generate computer executable code; and
generating the tax code model from the generated computer executable code.

5. The method of claim 4, wherein the determining tax rules comprises:
downloading a tax code file from a governmental agency;
feeding the tax code file to the generative AI tool;
instructing the generative AI tool to extract rules from the tax code file; and
saving the extracted rules to a database.

6. The method of claim 4, wherein the coding the tax rules comprises:
importing each of the tax rules; and
iteratively instructing the generative AI tool to process the imported tax rule one-by-one.

7. The method of claim 4, wherein the generating the tax code model comprises:
defining a tax bracket class, the tax bracket class including a plurality of tax brackets based on the tax code model;
defining a tax model class that provides a list of tax objects;
creating an instance of the tax model class to produce a tax mode instance; and
adding ones of the plurality of tax brackets to the tax model instance based on tax bracket information included in the personalized data.

8. The method of claim 1, wherein the building and running the tax engine on the tax savings model comprises:
populating engine constraints based on the personalized data and the market data; and
generating tax savings information using an engine run based on the engine constraints.

9. The method of claim 8, wherein the generating the tax savings information comprises:
running the tax engine based on the tax savings model, engine inputs, and the engine constraints, the engine inputs including the personalized data and the market data, the personalized data including tax bracket information to generate a target tax information;
calculating a current tax information for the client based on the tax bracket information included in the personalized data and the market data;
determining whether a tax savings provided to the client by implementing the tax savings model is greater than a threshold based on the target tax information and the current tax information; and
labeling the tax savings model differently based on a result of the determination to differentiate between ones of a plurality of tax savings models that provide sufficient tax savings and ones of the plurality of tax savings models that do not provide the sufficient tax savings.

10. The method of claim 9, wherein the running the tax engine comprises:
selecting an original security from a client account included in the personalized data;
selecting a replacement security from an index fund that meets an index fund cap weight;
calculating a present value of the replacement security;
selectively saving the tax savings provided to the client for the replacement security to a database based on whether the present value of the replacement security minus the a present value of the original security is less than or equal to a tax loss threshold; and
determining a sum of all the tax savings and storing same in the database.

11. The method of claim 1, wherein the training the computational models comprises:
retrieving, from a database a labeled version of the tax savings model;
splitting the labeled data into a training set, a validation set, and a test set;
training one of the computational models on the training set using a machine learning algorithm;
evaluating a performance of the trained computational model using the validation set;
generating a prediction using the trained computational model;
saving ones of the predictions that generate tax savings to the database; and
selectively tuning weights of parameters associated with the computational models, in response to a determining that the prediction is not within norms.

12. The method of claim 1, wherein the providing the recommendations comprises:
transmitting recommendations to a terminal of an advisor via an application program interface (API);
receiving a selection from the advisor over the API; and
transmitting data to the client based on a result of the selection.

13. An apparatus configured to improve computational models and provide recommendations in strategic planning, the apparatus comprising:
a memory; and
at least one processor configured to execute code stored in the memory to configure the apparatus to,
collect personalized data associated with a client and a market data,
generate a tax code model using a generative artificial intelligence (AI) tool,
build and run a tax engine on a tax savings model based on the personalized data and the market data, the tax code model, and tax engine constraints,
train the computational models based on results of running the tax engine on the tax savings model, and
provide recommendations using the results of running the tax engine and the trained computational models.

14. The apparatus of claim 13, wherein the at least one processor is configured to execute the code stored in the memory to further configure the apparatus to,
iteratively perform, using each of the plurality of tax savings models, the building and running of the tax engine and the training of the computational models, and
integrate ones of the tax savings models that provide sufficient tax savings to improve the computational models.

15. The apparatus of claim 13, wherein the at least one processor is configured to execute the code stored in the memory to configure the apparatus to collect the personalized data by,
collecting client account and tax information associated with the client, and
collecting subjective information associated with the client.

16. The apparatus of claim 13, wherein the at least one processor is configured to execute the code stored in the memory to configure the apparatus to generate the tax code model by,
extracting tax codes from tax code data to output an extracted tax code,
determining tax rules from the extracted tax code,
coding the tax rules to generate computer executable code, and
generating the tax code model from the generated computer executable code.

17. The apparatus of claim 13, wherein the at least one processor is configured to execute the code stored in the memory to configure the apparatus to build and run the tax engine on the tax savings model by,
populating engine constraints based on the personalized data and the market data, and
generating tax savings information using an engine run based on the engine constraints.

18. The apparatus of claim 17, wherein the at least one processor is configured to execute the code stored in the memory to configure the apparatus to generate the tax savings information by,
running the tax engine based on the tax savings model, engine inputs, and the engine constraints, the engine inputs including the personalized data and the market data, the personalized data including tax bracket information to generate a target tax information,
calculating a current tax information for the client based on the tax bracket information included in the personalized data and the market data,
determining whether a tax savings provided to the client by implementing the tax savings model is greater than a threshold based on the target tax information and the current tax information, and
labeling the tax savings model differently based on a result of the determination to differentiate between ones of a plurality of tax savings models that provide sufficient tax savings and ones of the plurality of tax savings models that do not provide the sufficient tax savings.

19. The apparatus of claim 13, wherein the at least one processor is configured to execute the code stored in the memory to configure the apparatus to train the computational models by,
retrieving from a database a labeled version of the tax savings model,
splitting the labeled data into a training set, a validation set, and a test set,
training one of the computational models on the training set using a machine learning algorithm,
evaluating a performance of the trained computational model using the validation set,
generating a prediction using the trained computational model,
saving ones of the predictions that generate tax savings to the database, and
selectively tuning weights of parameters associated with the computational models, in response to a determining that the prediction is not within norms.

20. The apparatus of claim 13, wherein the at least one processor is configured to execute the code stored in the memory to configure the apparatus to provide the recommendations by,
transmitting recommendations to a terminal of an advisor via an application program interface (API),
receiving a selection from the advisor over the API, and
transmitting data to the client based on a result of the selection.
